(19) United States
(12) Patent Application Publication
(10) Pub. No.: US 2025/0276663 A1
(43) Pub. Date: Sep. 4, 2025

(54) COOLING INTAKE DUCT STRUCTURE WITH BULLETPROOF GRILL FOR MILITARY HYBRID VEHICLES

(71) Applicant: AGENCY FOR DEFENSE DEVELOPMENT, Daejeon (KR)

(72) Inventors: Kyoung-Ho LEE, Daejeon (KR); Kwang-Seop KIM, Daejeon (KR); Sin-Cheon KANG, Daejeon (KR); Hyun-Ho CHOI, Daejeon (KR)

(21) Appl. No.: 18/941,329

(22) Filed: Nov. 8, 2024

(30) Foreign Application Priority Data
Feb. 29, 2024 (KR) 10-2024-0030061

(51) Int. Cl. B60R 19/52; B60K 11/08

(52) U.S. Cl. CPC B60R 19/52; B60K 11/08; B60R 2019/525

(57) ABSTRACT

Provided is a cooling intake duct structure (100) for a military hybrid vehicle, featuring a bulletproof grill (120) and a directional guide grill (130) installed at the front opening of an inclined duct housing (110). The bulletproof grill (120) serves to attenuate external threats (200), such as bullets and electromagnetic waves. Additionally, the directional guide grill (130) helps suppress secondary damage from bullet fragments or reduce electromagnetic interference. The structure also prevents water ingress into the air filter (140) or onboard equipment, ensuring smooth airflow towards the air filter (140) to maintain optimal cooling performance. The inclined duct housing (110) space traps incoming water and immediately discharges it through multiple drainage holes (112) to the exterior of the duct housing (110), preventing the air filter (140) from becoming wet, which would increase transmission loss, and thus helps to prevent cooling performance degradation.

### CROSS-REFERENCE TO RELATED APPLICATION

This application claims priority to Korean Patent Application No. 10-2024-0030061, filed on Feb. 29, 2024, which is incorporated herein by reference in its entirety.

### BACKGROUND OF THE DISCLOSURE

### 1. Field of the Disclosure

The present invention relates to a cooling intake duct structure for a military hybrid vehicle having a bulletproof grille. More specifically, it relates to a cooling intake duct structure for a military hybrid vehicle having a bulletproof grille that can protect mission equipment mounted inside the military hybrid vehicle from external threats and prevent water from entering the vehicle interior.

### 2. Description of Related Art

Generally, the bulletproof grilles of conventional special vehicles are mainly composed of intake and exhaust grilles, through which the flow of combustion air and cooling air must be transmitted smoothly. In order to meet the required cooling performance of the power unit, the shape of the intake and exhaust grilles has a certain gap spacing to ensure smooth air flow.

On the other hand, since special vehicles such as military armoured personnel carriers are exposed to external substances such as bullets, in addition to the aforementioned smooth cooling performance, the protection function of the main components inside the power unit compartment from external substances and the main threat is also considered as an important design factor.

In other words, the bulletproof grille of a specialized vehicle must be designed in such a way that its geometry and materials are designed to allow air to flow in and out, while effectively preventing the entry of bullets or shrapnel.

However, bulletproof grilles for specialized vehicles are limited to the design of grilles that ensure the bulletproof performance of the air intake, or the ability to drain water without allowing it to enter the engine or vehicle interior. As a result, they are limited in their ability to protect the mission equipment inside the vehicle in the complex threat environment to which military hybrid combat vehicles are exposed.

### SUMMARY OF THE DISCLOSURE

It is an object of the present invention to provide a cooling intake duct structure for a military hybrid vehicle having a bulletproof grille with a relatively simple structure that can protect the on-board equipment from external threats such as bullets, electromagnetic waves, and the like, and prevent water from entering the interior of the vehicle in an operational environment such as fording or under heavy rain.

A cooling air intake duct structure of a military hybrid vehicle having a bulletproof grille according to an embodiment of the present invention to solve the above technical problems, comprising: a duct housing as an air intake duct installed at the front of the vehicle; a bulletproof grille installed in a front opening of said duct housing; a directional grille installed at the rear of said bulletproof grille with respect to the front interior of said duct housing; and an air filter installed at the rear opening of said duct housing, characterized in that the front surface of said duct housing is formed with a plurality of drainage holes spaced at regular intervals along both side directions of said duct housing.

Said duct housing, characterized in that the top surface and the bottom surface are inclined to become lower towards the front, so that said top surface protrudes further forward than said bottom surface, and a front opening is formed between said top surface and said bottom surface.

Said bulletproof grille, characterized in that it comprises: a first grille support in the form of a square ring mounted correspondingly to an edge of said front opening of said duct housing; and a plurality of first louvers mounted to slope upwardly from front to rear at regular intervals above and below the opening of said first grille support.

The plurality of said first louvers is characterized in that the thickness is uniform along its horizontal and vertical sides and the length and width is identical forming a straight-line configuration.

Said directional induction grille, characterized in that it comprises: a second grille support in the form of a square ring mounted correspondingly to said front opening edge of said duct housing; and a plurality of second louvers mounted to slope upwardly and downwardly at regular intervals to match the spacing between the rear sides of said plurality of first louvers with respect to the opening of said second grille support.

The plurality of said second louvers are characterized in that they have the same transverse and longitudinal thickness, length, and width in a straight shape.

The plurality of said second louvers are characterized in that they have the same transverse and longitudinal thickness, length, and width, said width being an S-shape curved from front to back.

The plurality of said second louvers is characterized in that said top surface and said bottom surface of said duct housing are sloped at the same angle of inclination that decreases towards the front.

The plurality of said first louvers are characterized in that they are formed with a greater thickness than the plurality of said second louvers.

The plurality of first louvers is characterized in that the plurality of first louvers is made of a higher strength material than the plurality of second louvers.

The plurality of said first louvers is characterized in that the plurality of said first louvers has a narrower upper and lower spacing than the plurality of said second louvers.

The plurality of said first louvers and the plurality of said second louvers are characterized in that they form an obtuse angle.

Characterized in that a plurality of drainage holes is formed on the front surface of said duct housing at regular intervals along both lateral directions of said duct housing.

The present invention is a cooling intake duct structure of a military hybrid vehicle in which a bulletproof grille and a directional guidance grille are installed in the front opening of an inclined duct housing.

Therefore, the bulletproof grille can attenuate external threats such as bullets and electromagnetic waves, and the directional guidance grille can suppress secondary damage caused by bullet fragments of threats or attenuate electromagnetic waves, and the incoming air can be smoothly guided to the air filter while suppressing the infiltration of water into the air filter or on-board equipment to secure cooling performance.

The inclined duct housing space traps the incoming water and immediately discharges it to the outside of the duct housing through multiple drainage holes to prevent the air filter from getting wet and increasing the transmission loss, and to prevent the cooling performance from decreasing.

### BRIEF DESCRIPTION OF THE DRAWINGS

FIG. 1 is an illustrative view of a military hybrid vehicle having a ballistic grille according to the present invention.

FIG. 2 is an exterior view of an intake duct according to one embodiment of the present invention.

FIG. 3 is an illustrative cross-sectional view of line A-A of FIG. 2, in a water drainage path state.

FIG. 4 is an illustrative cross-sectional view of the A-A lines of FIG. 2, in the state of threat protection.

FIG. 5 is an exemplary interior view of an intake duct according to another embodiment of the present invention.

### DETAILED DESCRIPTION OF SPECIFIC EMBODIMENTS

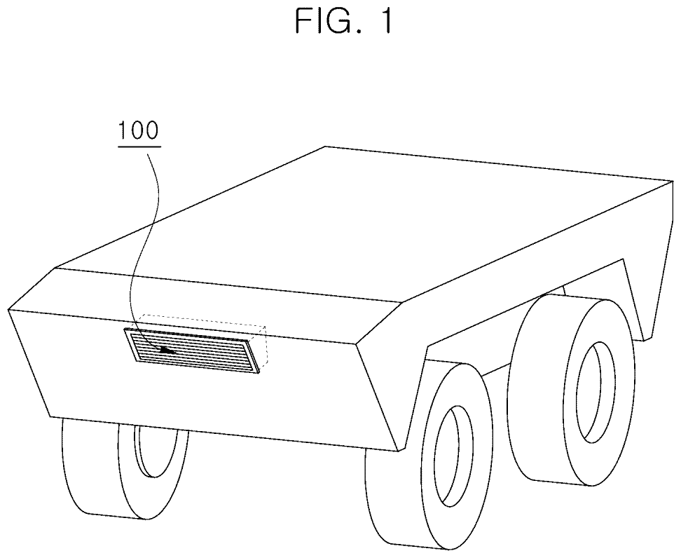

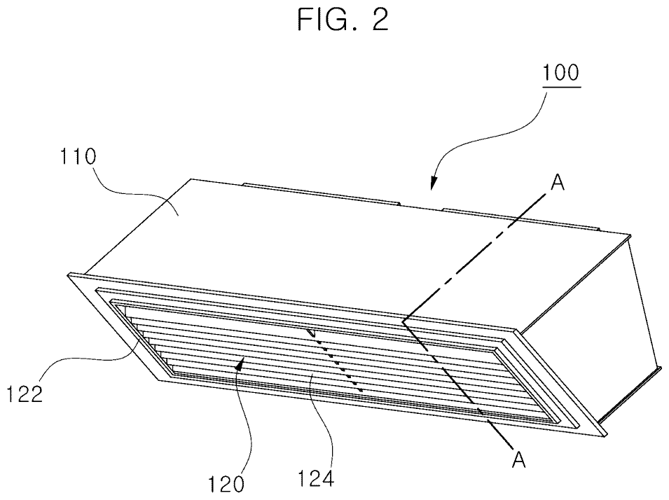

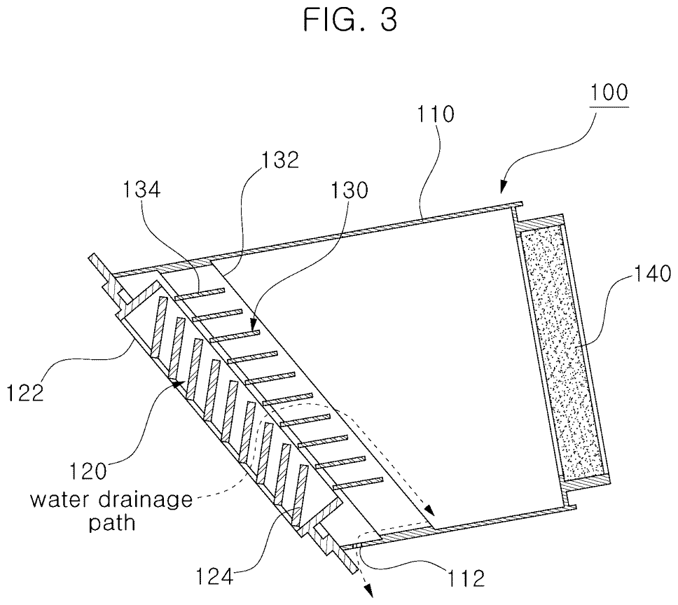

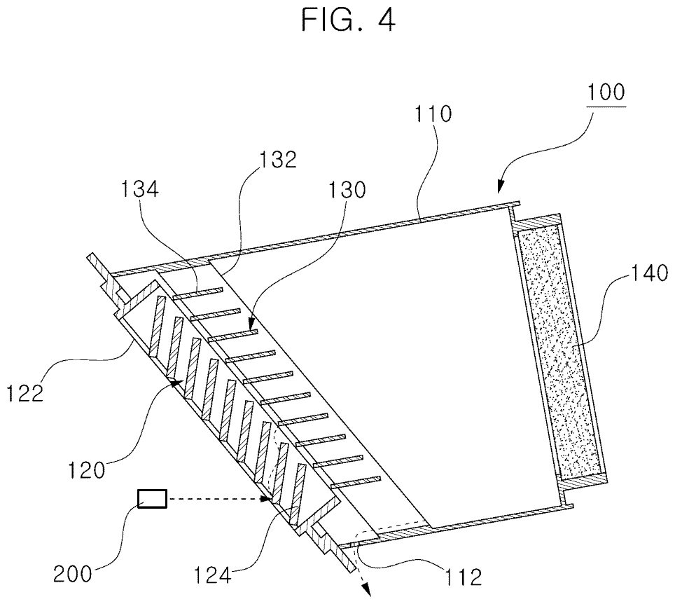

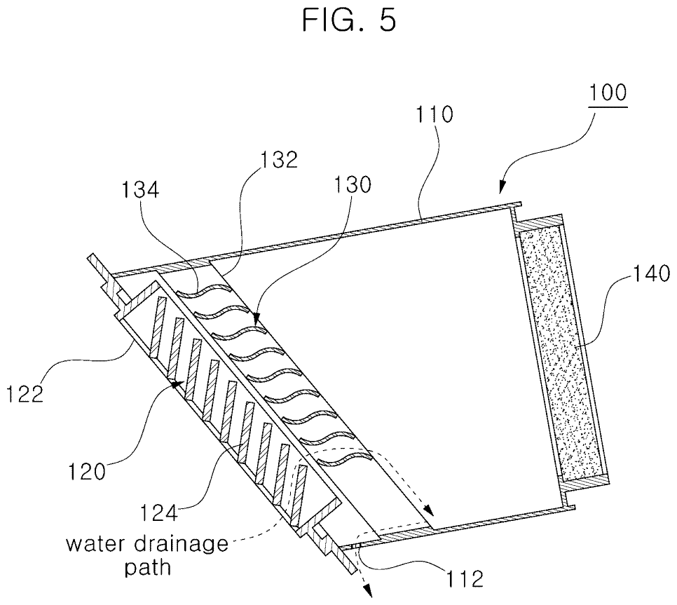

In the following, preferred embodiments of the present invention will be described with reference to the accompanying drawings, FIGS. 1 to 5, for a full understanding of the invention. Embodiments of the invention may be modified in many ways and should not be construed as limiting the scope of the invention to the embodiments described in detail below. It should be noted that in each drawing, identical configurations are sometimes shown with the same reference numerals. Detailed descriptions of known features and configurations are omitted where it is believed that they would unnecessarily obscure the essence of the present invention.

Referring now to FIGS. 1 to 4, a cooling intake duct structure for a military hybrid vehicle having a bulletproof grille is installed at the front of the vehicle according to one embodiment of the present invention and comprises an intake duct 100, a duct housing 110, a bulletproof grille 120, a directional guidance grille 130, and an air filter 140.

The duct housing 110 is sloped such that the top surface and the bottom surface are lower towards the front, with the top surface projecting further forward than the bottom surface, a front opening is formed between the top surface and the bottom surface, and a plurality of drainage holes 112 are formed on the front surface at regular intervals along both sides of the duct housing 110 to facilitate drainage of water that has entered the interior of the duct housing 110.

Since the duct housing 110 is inclined downwardly at the front, it has the advantage of trapping water that has entered the inner space of the duct housing 110 and directing it to be immediately discharged to the outside of the duct housing 110 through the plurality of drainage holes 112, so that the air filter 140 can be suppressed from becoming wet with water and increasing the transmission loss, thereby preventing the cooling performance from deteriorating.

The bulletproof grille 120 is installed in the front opening of the duct housing 110 to attenuate the penetration of threats 200, such as bullets or electromagnetic waves, into the interior of the duct housing 110, and comprises a first grille support 122 and a plurality of first louvers 124.

That is, said first grille support 122 is preferably formed in the form of a square ring that is installed correspondingly to the front opening edge of the duct housing 110.

A plurality of said first louvres 124 are mounted on the opening of the first grille support 122 at regular intervals up and down and sloping upwards from front to rear, and are preferably formed in a straight shape with the same transverse and longitudinal thickness, length, and width to have dimensions suitable for the type of threat 200.

The directional guidance grille 130, which is installed at the rear of the bulletproof grille 120 with respect to the front interior of the duct housing 110 to attenuate electromagnetic waves from the threatening object 200 and to guide incoming air to the air filter 140 while preventing debris and water from the threatening object 200 from penetrating into the air filter 140 or the onboard equipment installed at the rear opening in the duct housing 110, comprises a second grille support 132 and a plurality of second louvers 134 made of a material having a certain amount of friction.

That is, said second grille support 132 is preferably formed in the form of a square ring which is installed correspondingly on the front opening edge of the duct housing 110.

The plurality of second louvres 134 are sloped upwardly and downwardly at regular intervals to match the spacing between the rearward sides of the plurality of first louvres 124 with respect to the opening of the second grille support 132.

Preferably, they are formed in a straight shape with equal transverse and longitudinal thicknesses, lengths, and widths, or in an S-shaped shape with equal transverse and longitudinal thicknesses, lengths, and widths and a curved width from front to rear.

The plurality of second louvers 134 are also preferably arranged so that the upper surface and the lower surface of the duct housing 110 are inclined at the same angle of inclination that decreases towards the front.

In this case, the plurality of first louvers 124 are thicker than the plurality of second louvers 134 and are made of a stronger material, so that the difference in thickness between the first louvers 124 and the second louvers 134 can reduce the weight of the intake duct 100 while increasing the bulletproof effect of the first louvers 124 and the attenuation effect of the debris and electromagnetic waves of the threatening object 200 by the second louvers 134, and at the same time increase the suppression effect of the incoming water.

The plurality of first louvers 124 are spaced apart from the plurality of second louvers 134 by a certain distance up and down, so as to minimize the penetration of bullet fragments and electromagnetic waves of the threatening object 200 through the spacing of the first louvers 124, and to guide the air introduced through the spacing of the second louvers 134 to flow smoothly towards the air filter 140 to secure cooling performance.

Preferably, the plurality of first louvers 124 and the plurality of second louvers 134 are configured to form an obtuse angle.

Thus, since the present invention is a cooling intake duct 100 structure of a military hybrid vehicle with a bulletproof grille 120 and a directional grille 130 installed in the front opening of the sloped duct housing 110, external threats such as bullets and electromagnetic waves can be attenuated through the bulletproof grille 120.

In addition to suppressing secondary damage caused by bullet fragments or attenuating electromagnetic waves from the threatening object 200 through the directional grille 130, the incoming air can be smoothly guided to the air filter 140 while suppressing water from penetrating into the air filter 140 or onboard equipment to secure cooling performance.

The inclined duct housing 110 has the advantage of trapping the incoming water in the space of the duct housing 110 while immediately discharging it to the outside of the duct housing 110 through the plurality of drainage holes 112, thereby preventing the air filter 140 from becoming wet and increasing the transmission loss and preventing the cooling performance from deteriorating.

On the other hand, the present invention is not limited to the above-described embodiments, but can be practiced with modifications and modifications without departing from the spirit of the invention, and the technical idea with such modifications and modifications should also be regarded as falling within the scope of the following patent claims.

What is claimed is:

1. A cooling intake duct structure for a military hybrid vehicle with a bulletproof grill, comprising:
a duct housing (110);
a bulletproof grill (120) installed at a front opening of said duct housing (110);
a directional guide grill (130) installed at a rear side of said bulletproof grill (120) within the front interior of said duct housing (110) to guide airflow direction;
an air filter (140) installed at a rear opening of said duct housing (110); and
a plurality of drainage holes (112) formed at the front bottom surface of said duct housing (110) along the lateral direction at regular intervals,
wherein said cooling intake duct structure is configured to enable effective airflow and drainage for said military hybrid vehicle.

2. The cooling intake duct structure of claim 1, wherein said duct housing (110) is characterized in that the upper surface and lower surface are inclined to gradually lower toward the front, with said upper surface protruding further forward than said lower surface, forming a front opening between said upper and lower surfaces.

3. The cooling intake duct structure of claim 2, wherein said bulletproof grill (120) comprises:
a rectangular ring-shaped first grill support (122) installed to correspond to the edge of the front opening of said duct housing (110); and
a plurality of first louvers (124) installed within the opening of said first grill support (122) at regular vertical intervals and inclined upwardly from front to rear.

4. The cooling intake duct structure of claim 3, wherein each of said plurality of first louvers (124) has uniform thickness along its horizontal and vertical sides, and identical length and width, forming a straight-line configuration.

5. The cooling intake duct structure of claim 3, wherein said directional guide grill (130) comprises:
a rectangular ring-shaped second grill support (132) installed to correspond to the edge of the front opening of said duct housing (110); and
a plurality of second louvers (134) installed within the opening of said second grill support (132) at regular vertical intervals and inclined to match the spacing between the rear sides of said plurality of first louvers (124).

6. The cooling intake duct structure of claim 5, wherein each of said plurality of second louvers (134) has uniform thickness along its horizontal and vertical sides, and identical length and width, forming a straight-line configuration.

7. The cooling intake duct structure of claim 5, wherein each of said plurality of second louvers (134) has uniform thickness along its horizontal and vertical sides, identical length and width, and an S-shaped curve in its width extending from the front to the rear.

8. The cooling intake duct structure of claim 5, wherein the angle of inclination of said plurality of second louvers (134) is the same as the angle of inclination of said top surface of said duct housing (110) and said bottom surface, decreasing toward the front.

9. The cooling intake duct structure of claim 5, wherein each of said plurality of first louvers (124) is formed with a greater thickness than each of said plurality of second louvers (134).

10. The cooling intake duct structure of claim 5, wherein each of said plurality of first louvers (124) is made of a material with higher strength than that of each of said plurality of second louvers (134).

11. The cooling intake duct structure of claim 5, wherein said plurality of first louvers (124) are spaced closer together vertically than said plurality of second louvers (134).

12. The cooling intake duct structure of claim 5, wherein said plurality of first louvers (124) and said plurality of second louvers (134) form an obtuse angle with each other.
